(19) United States
(12) Patent Application Publication
(10) Pub. No.: US 2010/0215957 A1
(43) Pub. Date: Aug. 26, 2010

(54) FIBER CROSS-LINKED BODY AND MANUFACTURING METHOD OF FIBER CROSS-LINKED BODY

(75) Inventor: Takeharu TAJIMA, Sodegaura-shi (JP)

Correspondence Address: MILLEN, WHITE, ZELANO & BRANIGAN, P.C., 2200 CLARENDON BLVD., SUITE 1400, ARLINGTON, VA, 22201, US

(73) Assignee: IDEMITSU TECHNOFINE CO., LTD., Sumida-ku (JP)

(21) Appl. No.: 12/708,772

(22) Filed: Feb. 19, 2010

(30) Foreign Application Priority Data
Feb. 20, 2009 (JP) 2009-038652

(51) Int. Cl. D02G 3/22; D01D 5/06; C08F 24/00

(52) U.S. Cl. 428/401; 264/465; 525/54.1

(57) ABSTRACT

A cross-linked fiber is provided by cross-linking a fiber made of polyglutamic acid sodium of molecular weight of 200,000 or more and a polymer cross-linking agent. The polymer cross-linking agent is preferably a polymer having an oxazoline group or a polymer having an epoxy group. The cross-linked fiber is manufactured by: spinning threads from a solution in which the material is mixed by an electrostatic spinning to form a fiber and a fiber assembly; and heating the fiber and the fiber assembly to form the cross-linked fiber.

### CROSS-LINKED BODY

The entire disclosure of Japanese Patent Application No. 2009-038652 filed Feb. 20, 2009 is expressly incorporated by reference herein.

### BACKGROUND OF THE INVENTION

1. Field of the Invention

The present invention relates to a cross-linked fiber and manufacturing method of the cross-linked fiber.

2. Description of Related Art

Polyglutamic acid has been known as a material forming threads of natto (Japanese local food made of soybeans), which has come to attract attention as a resin that is excellent in biodegradability, biocompatibility and water-absorptivity. Recently, industrial production of the polyglutamic acid has become possible.

For instance, it is known that polyglutamic acid is cross-linked to form a gel, which is used as a moisturizing agent of cosmetics and the like and that polyglutamic acid is contained in a fiber (see, for instance, Literature 1: JP-Patent-3737749, Literature 2: JP-A-10-251402 and Literature 3: JP-A-2004-321484).

The Literature 1 discloses a fiber impregnated with poly-γ-glutamic acid.

The Literature 2 discloses a gel provided by chemically cross-linking polyglutamic acid.

The Literature 3 discloses a medical material using a fiber formed of nanofibers of a polymer containing polyglutamic acid.

However, since poly-γ-glutamic acid is impregnated in an existing fiber product in the Literature 1, only a little amount of poly-γ-glutamic acid is contained in the fiber product. Further, the properties of the fiber basically depend on the fiber material to be processed, where the properties of polyglutamic acid such as biodegradability are not exhibited in the produced fiber.

In the Literature 2, though the gel water-absorbing resin formed of poly-γ-glutamic acid has excellent water-absorptivity, nanofiber product is not obtained.

In the Literature 3, when non-woven fabric formed of fibers simply using polyglutamic acid is left for a long time while being soaked with water, the non-woven fabric becomes water-soluble, which is hardly usable as fiber.

### SUMMARY OF THE INVENTION

An object of the invention is to provide a cross-linked fiber that exhibits excellent biodegradability, biocompatibility and moisture (water)-absorptivity and also has such a water resistance that the fiber is not soluble to water, and a manufacturing method of the cross-linked fiber.

In view of the above object, a cross-linked fiber and a method for manufacturing the cross-linked fiber as follows are provided in the invention.

(1) A cross-linked fiber according to an aspect of the invention includes: a hydrophilic compound including a condensing functional group; and a polymer cross-linking agent, the hydrophilic compound and the polymer cross-linking agent being cross-linked to provide a fibrous form, in which a degree of insolubility represented by a formula (1) as follows is 20% or more,

Degree of insolubility (%)=M_{A}/M_{B}×100 (1)

where M_{A} represents a mass of the cross-linked fiber that is dried after being immersed in water and M_{B} represents a mass of the cross-linked fiber before being immersed in water.
(2) In the above aspect of the invention, the hydrophilic compound including the condensing functional group is preferably polyglutamic acid.
(3) In the above aspect of the invention, the polymer cross-linking agent is preferably a polymer having an oxazoline group.
(4) In the above aspect of the invention, the polymer cross-linking agent is preferably a polymer having an epoxy group.
(5) In the above aspect of the invention, the cross-linked fiber is preferably further cross-linked using a monomer cross-linking agent.
(6) In the above aspect of the invention, the cross-linked fiber is preferably further subjected to an astringent process by an astringent agent.
(7) In the above aspect of the invention, a diameter of the cross-liked fiber is preferably in a range from 0.01 μm to 3 μm.
(8) In the above aspect of the invention, the cross-linked fiber preferably constitutes a fiber assembly.
(9) A manufacturing method of a cross-linked fiber according to another aspect of the invention includes: spinning threads from a solution containing the hydrophilic compound including the condensing functional group and the polymer cross-linking agent by an electrostatic spinning to form fibers and a fiber assembly; and heating the fiber and the fiber assembly to provide the cross-linked fiber.
(10) The manufacturing method of a cross-linked fiber according to the above aspect of the invention, after the heating, preferably has at least one of: cross-linking the cross-linked fiber by a monomer cross-linking agent; and an astringent process by an astringent agent.

According to the above aspects of the invention, a cross-linked fiber that exhibits excellent biodegradability, biocompatibility and moisture(water)-absorptivity and has such water resistance that the fiber is not dissolved in water even when the fiber absorbs moisture and/or water, and a manufacturing method of the cross-linked fiber are provided.

### BRIEF DESCRIPTION OF THE DRAWINGS

FIG. 1 is an enlarged photograph showing a cross-linked fiber according to Example 1 before being tested.

FIG. 2 is an enlarged photograph showing the cross-linked fiber according to Example 1 after a moisture absorption test.

FIG. 3 is an enlarged photograph showing the cross-linked fiber according to Example 1 after a water resistance test.

FIG. 4 is an enlarged photograph showing a cross-linked fiber according to Example 2 before being tested.

FIG. 5A is an enlarged photograph showing the cross-linked fiber according to Example 2 after the moisture absorption test.

FIG. 5B is another enlarged photograph showing the cross-linked fiber according to Example 2 after the moisture absorption test.

FIG. 6 is an enlarged photograph showing a cross-linked fiber according to Example 3 before being tested.

FIG. 7A is an enlarged photograph showing the cross-linked fiber according to Example 3 after the moisture absorption test.

FIG. 7B is another enlarged photograph showing the cross-linked fiber according to Example 3 after the moisture absorption test.

FIG. 8 is an enlarged photograph showing a cross-linked fiber according to Example 4 before being tested.

FIG. 9A is an enlarged photograph showing the cross-linked fiber according to Example 4 after the moisture absorption test.

FIG. 9B is another enlarged photograph showing the cross-linked fiber according to Example 4 after the moisture absorption test.

FIG. 10 is an enlarged photograph showing a cross-linked fiber according to Example 5 after the moisture absorption test.

FIG. 11 is an enlarged photograph showing the cross-linked fiber according to Example 5 after the water resistance test.

FIG. 12 is an enlarged photograph showing a cross-linked fiber according to Example 6 after the moisture absorption test.

FIG. 13A is an enlarged photograph showing the cross-linked fiber according to Example 6 after the water resistance test.

FIG. 13B is another enlarged photograph showing the cross-linked fiber according to Example 6 after the water resistance test.

FIG. 14 is an enlarged photograph showing a cross-linked fiber according to Example 7 before being tested.

FIG. 15 is an enlarged photograph showing the cross-linked fiber according to Example 7 after the moisture absorption test.

FIG. 16 is an enlarged photograph showing the cross-linked fiber according to Example 7 after the water resistance test.

FIG. 17 is an enlarged photograph showing a cross-linked fiber according to Comparative Example 1 before being tested.

FIG. 18 is an enlarged photograph showing a cross-linked fiber according to Comparative Example 1 after the moisture absorption test.

FIG. 19 is a photograph showing the cross-linked fibers according to Examples that are subjected to the water resistance test.

### DETAILED DESCRIPTION OF PREFERRED EMBODIMENT(S)

An exemplary embodiment of the invention will be described below.

In this exemplary embodiment, a solution containing a hydrophilic compound including a condensing functional group, a polymer cross-linking agent and an auxiliary agent is subjected to a spinning process by an electrostatic spinning to form a fiber and fiber assembly. Then, the fiber and the fiber assembly are cross-linked to form a cross-linked fiber.

### 1. Material

### 1-1. Hydrophilic Compound Containing Condensing Functional Group

The condensing functional group refers to a functional group that is adapted to a condensation reaction with a functional group owned by the polymer cross-linking agent. Examples of the condensing functional group are amino group, hydroxyl group, carbonyl group, carboxyl group, silanol group, ester group and amide group. When the functional group owned by the polymer cross-linking agent is an oxazoline group, carboxyl group is preferable in terms of high reactivity thereof.

Examples of the hydrophilic compound including the condensing functional group include various compounds such as aliphatic and aromatic low-molecular organic compounds, high-molecular compounds, vinyl monomers, metal complexes and biological compounds that contain the condensing functional group. Examples of the low-molecular organic compounds are: hydroxyl-group-containing compounds such as ethanol, ethylene glycol and glycerol; amino-group-containing compounds such as ethylenediamine; and carboxyl-group-containing compounds such as acetic acid, maleic acid and phthalic acid. Examples of the high-molecular compounds are: hydroxyl-group-containing polymers such as cellulose; amino-group-containing polymers such as polyethyleneimine; and carboxylic-group-containing polymers such as various copolymers containing poly(meth)acrylic acid or (meth)acrylic acid. Examples of the biological compounds are amino acids, proteins, cellulose derivatives such as chitosan, moisture-retaining polymers such as hyaluronic acid and chondroitin sulfate, oils and fats, vitamins and other physiological active substances. Preferable examples are amino acids, chitosan, cellulose derivatives and hyaluronic acid, among which polyglutamic acid is especially preferable.

In this exemplary embodiment, polyglutamic acid salt is used as the hydrophilic compound including a condensing functional group. Polyglutamic acid is a polymer that has a linear connection of glutamic acids (a kind of amino acid), which has properties such as biodegradability and biocompatibility.

Any polyglutamic acid salt may be used as long as molecular weight thereof is 200,000 or more, which may be obtained by a known method or may be obtained from a nature product. When the molecular weight is less than 200,000, particles may only be generated when being spun by electrostatic spinning, so that fiber is difficult to be obtained. Polyglutamic acid of D-form and L-form and various derivatives thereof may be used, among which poly-γ-glutamic acid sodium is preferably used in terms of water-absorptivity and water-retaining property and stable industrial availability thereof.

### 1-2. Polymer Cross-Linking Agent

The polymer cross-linking agent may be provided with an oxazoline group or an epoxy group that can be cross-linked with carboxyl group of polyglutamic acid.

An example of the polymer cross-linking agent having an oxazoline group is a substance provided by a vinyl monomer having a 2-oxazoline group represented by the following general formula (1), which is polymerized with, as necessary, at least one of other vinyl monomers.

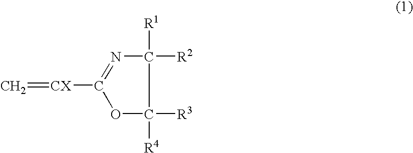

In the above formula, X represents a hydrogen atom or a methyl group and R¹, R², R³ and R⁴ respectively independently represent one of hydrogen atom, alkyl group, phenyl group, substituted phenyl group and halogen group.

Specific examples of the vinyl monomer having 2-oxazoline group include 2-vinyl-2-oxazoline, 2-vinyl-4-methyl-2-oxazoline, 2-vinyl-5-methyl-2-oxazoline, 2-isopropenyl-2-oxazoline, 2-isopropenyl-4-methyl-2-oxazoline and 2-isopropenyl-5-methyl-2-oxazoline, among which 2-isopropenyl-2-oxazoline is preferable in terms of industrial availability.

Any vinyl monomer that does not react with 2-oxazoline group but is copolymerizable with the vinyl monomer having 2-oxazoline group may be used as the other vinyl monomer. Examples of the other vinyl monomer are: (meth)acrylic acid esters such as methyl (meth)acrylate, butyl (meth)acrylate, 2-ethylhexyl (meth)acrylate, (meth)acrylate methoxy polyethylene glycol, 2-hydroxyethyl (meth)acrylate, 2-aminoethyl (meth)acrylate and salt thereof; unsaturated nitriles such as (meth)acrylonitrile; unsaturated amides such as (meth)acrylamide, N-methylol (meth)acrylamide and N-(2-hydroxyethyl)(meth)acrylamide; vinyl esters such as vinyl acetate and vinyl propionate; vinyl ethers such as methyl vinyl ether and ethyl vinyl ether; α-olefins such as ethylene and propylene; halogen-containing monomers such as vinyl chloride, vinylidene chloride and vinyl fluoride; aromatic-functional-group-containing monomers such as styrene, α-methyl styrene and sodium styrenesulfonate; and a mixture of at least two of the above substances.

The polymer containing oxazoline group may be polymerized in any manner, where various polymerizations such as emulsion polymerization, solution polymerization, bulk polymerization and suspension polymerization may be selected as desired.

Examples of the polymer cross-linking agent having an epoxy group include polyethylene glycol diglycidylether.

The amount of the polymer cross-linking agent is preferably in a range of 0.1 mass % to 50 mass % relative to polyglutamic acid in terms of solid content, more preferably in a range of 0.1 mass % to 20 mass %. When the amount of the polymer cross-linking agent is less than 0.1 mass %, the resultant cross-linked fiber may not be sufficiently cross-linked, so that the cross-linked fiber may be dissolved in water. On the other hand, when the amount of the polymer cross-linking agent exceeds 50 mass %, the properties (i.e. biodegradability, biocompatibility, moisture-and-water absorptivity and water-retaining property) of polyglutamic acid sodium may be hindered.

Such a polymer cross-linking agent can be cross-linked with polyglutamic acid sodium by being subjected to a heat processing. Since the polymer cross-linking agent is thermally cross-linked in a solid state, the degree of insolubility (cross-linking degree) can be enhanced while preserving the fiber structure. As necessary, a known cross-linking process such as electron-beam cross-linking, ultraviolet cross-linking, radiation cross-linking and immersion into a glutaraldehyde cross-linking agent may also be applied.

### 1-3. Auxiliary Agent

Various auxiliary agent(s) may be added as necessary.

For instance, when the solution is acidized by an acid such as hydrochloric acid, acetic acid, oxalic acid, malic acid and citric acid, the reaction between polyglutamic acid and oxazoline group or epoxy group, i.e. between polyglutamic acid sodium and polymer cross-linking agent, is accelerated, thereby improving water resistance of the resultant cross-linked fiber.

It is necessary that the amount of the blended acid is sufficient to acidize the blended solution to a level of pH7 or less, preferably to a level of pH5 or less. Incidentally, when the acidity of the solution is more than pH7, the cross-linking process may not progress.

A binder may be added as necessary. Known binders may be used, an example of which includes synthetic polymer that is soluble to a solvent, such as polylactate, polyvinyl alcohol, polyvinyl acetate, polyprorylene oxide, polyethylene imide, polyaniline, polymethyl methacrylate, polyacrylonitrile, polyurethane, silicone, polyvinylidene fluoride, polyvinyl chloride, polyvinylidene chloride, polyethylene, polypropylene, nylon, polyethylene sulfide, polystyrene, polybutadiene and polyethylene terephthalate. Alternatively, a natural polymer such as collagen, gelatin, starch, cellulose, chitin, chitosan, sericin, fibroin, nucleic acid, hyaluronic acid, elastin, heparin and catechin may be used. Further alternatively, a sol solution of organosilica and organotitanium may be used.

The solvent in which polyglutamic acid salt is to be dissolved is water and water-soluble organic solvent. Especially when polyglutamic acid sodium is used, though polyglutamic acid sodium is water-soluble, a water-soluble organic solvent is used together with water in order to enhance spinnability during electrostatic spinning.

The water-soluble organic solvent is selected as desired among those that can be mixed with polyglutamic acid salt aqueous solution. Examples of the usable water-soluble organic solvent include acetone, N,N-dimethylformamide and N,N-dimethylacetoamide as well as alcohols such as methanol, ethanol, propanol and isopropanol. Among the above, methanol, ethanol and propanol (i.e. aliphatic lower alcohol having 1 to 3 carbons) are preferably used in terms of handlability and cost. The water-soluble organic solvent may be singularly used or, alternatively, may be used in combination.

As necessary, surfactant, metal salt thickener, coloring material, preservative and various stabilizing agent may be used.

Any known surfactants such as anionic surfactant, cationic surfactant, nonionic surfactant and ampholytic surfactant may be used. Specific examples of the surfactant include: anionic surfactant such as p-nonylbenzene sulfonate sodium, lauryloxy sulfonate sodium and lauryloxy phosphate disodium; cationic surfactant such as lauryl trimethyl ammonium chloride and cetyl pyridinium chloride; nonionic surfactant such as polyethylene glycol stearate and pentaerythrite stearate monoester; and ampholytic surfactant such as lauryl dimethyl petain, which may be singularly used or used in combination.

Examples of the metal salt include metal chloride, metal bromide and metal iodide.

Examples of the thickener are natural polymer thickeners including cellulose derivatives such as methyl cellulose and hydroxy ethyl cellulose, gums, pectine, alginate sodium, dextrin, agar and gelatin.

### 2. Manufacturing Method

Polyglutamic acid in the form of polyglutamic acid sodium is used, which is mixed with a polymer cross-linking agent and an auxiliary agent at a predetermined blend ratio in a solvent to prepare a solution.

The prepared solution is subjected to an electrostatic spinning (electrospinning) in which the solution is electrically charged to form threads, thereby forming a fiber and fiber assembly.

Subsequently, the fiber assembly is subjected to a heating process to form a cross-linked fiber. As necessary, a known cross-linking process such as electron-beam cross-linking, ultraviolet cross-linking, radiation cross-linking and immersion into a glutaraldehyde cross-linking agent may also be applied.

The cross-linked fiber prepared by the above cross-linking process is subjected to a further cross-linking process using a monomer cross-linking agent. Examples of the monomer cross-linking agent include divenylbenzene, glutaraldehyde, diacrylate and dimethacrylate. According to the above process, a cross-linked fiber that is not easily dissolved even after absorbing moisture and is capable of retaining fibrous form can be provided.

The cross-linked fiber is further subjected to an astringent process using an astringent agent. Examples of the astringent agent include alum, tannin, persimmon tannin and bismuth. According to the above process, a cross-linked fiber that is not easily dissolved even after absorbing moisture and is capable of retaining fibrous form can be provided.

Either one of the cross-linking process and the astringent process may be conducted or, alternatively, both of the processes may be conducted.

The diameter of the fiber of thus formed fiber assembly and cross-linked fiber is in a range from 0.01 μm to 3 μm. The fiber diameter is preferably in a range from 0.05 μm to 1.8 μm. When the fiber diameter exceeds 3 μm, filter performance and water-absorptivity due to wide surface area that are specific to a microfiber deteriorate, thereby possibly causing stiff touch. On the other hand, when the fiber diameter is less than 0.01 μm, productivity, strength and handlability may be hindered.

Accordingly, the fiber diameter within the above range keeps the large surface area of the fiber assembly and the cross-linked fiber and ensures the formation of fine pores between the fibers. The fine pores easily catch moisture and does not easily release the caught moisture. Accordingly, excellent water-absorptivity and water-retaining property can be provided to the fiber assembly and the cross-linked fiber.

### 3. Advantages of Exemplary Embodiment

The above exemplary embodiment provides the following advantages.

The polyglutamic acid used in the exemplary embodiment has excellent biodegradability and biocompatibility. Accordingly, the polyglutamic acid cross-linked fiber obtained by spinning the solution containing polyglutamic acid sodium also has excellent biodegradability and biocompatibility.

In the exemplary embodiment, the solution containing polyglutamic acid sodium and polymer cross-linking agent is subjected to electrostatic spinning to form a fiber assembly. According to the electrostatic spinning, the threads can be further thinned by increasing electrical charge and, in accordance with the thinning of the threads, the volatilization of the solvent can be enhanced, thereby obtaining ultrafine fibers. Accordingly, the surface area to be in contact with the moisture invaded in the cross-linked fiber increases, thereby exhibiting excellent moisture(water)-absorptivity. Further, since the cross-linked fiber is an ultrafine fiber, the fiber assembly exhibits excellent touch and flexibility. Further, since water and the water-soluble organic solvent are used as the solvent in the exemplary embodiment, the resultant fiber can be produced at a low cost and easy handlability.

A polymer cross-linking agent is blended with polyglutamic acid sodium in this exemplary embodiment. The mixed solution is spun by electrostatic spinning to form a fiber and fiber assembly. The fiber and the fiber assembly are subjected to a heating process. The cross-linking occurs by a ring-opening polymerization between the carboxyl group of polyglutamic acid and the functional group of the polymer cross-linking agent so that the cross-linked fiber is formed. Since polyglutamic acid and the functional group of the polymer cross-linking agent of thus obtained cross-linked fiber are cross-linked, the cross-linked fiber is not easily dissolved into water. Accordingly, a product that does not become water-soluble but exhibits excellent water resistance even after the cross-linked fiber is left for a long time while absorbing moisture and/or water can be provided.

Further, since the cross-linked fiber can be provided only by heating the fiber and fiber assembly, thus requiring only a heating equipment for the heating process, the fiber can be economically produced.

### EXAMPLES

The advantages of the invention were confirmed through the following Examples and Comparative Examples. Incidentally, it should be understood that the scope of the invention is not limited by these Examples.

A polyglutamic acid solution was prepared using: polyglutamic acid sodium “HM-NaFORM” (molecular weight 1,300,000 Da) manufactured by VEDAN ENTERPRISE CORP.; 25% aqueous solution of oxazoline-group-containing polymer cross-linking agent “WS-770” manufactured by NIPPON SHOKUBAI CO., LTD.; and epoxy-group-containing polymer cross-linking agent “EPIOL E-400” manufactured by NOF CORPORATION in a blend ratio described in the following Examples 1 to 7 and Comparative Examples 1 to 3.

The molecular weight was measured with a differential refractive index detector by dissolving 5 ml of polyglutamic acid sodium in 1 ml of water through a gel permeation chromatography using “LC-10ADvp system” manufactured by Shimadzu Corporation and a column “SHODEX ASAHIPAK GS-710+GS-310 7G” manufactured by Showa Denko K.K. at a room temperature in a mobile phase of (50 mmol/l of phosphate buffer)+(0.3 mol/l of NaCl aqueous solution) at a rate of 0.7 ml/min.

Next, “NS-LAB200S” manufactured by Elmarco s.r.o. was used for electrostatic spinning. The distance between the electrodes was in a range from 100 mm to 110 mm, the voltage was in a range from 40 kV to 75 kV, the rotation speed of the electrode was 4 r/min and line speed was 0.08 m/min. The prepared polyglutamic acid solution was electrostatically spun by the device to obtain a deposit of nanofibers on a polypropylene nonwoven fabric (“RC2030” of 30 g/m² weight, manufactured by Idemitsu Unitech Co., Ltd.).

Subsequently, the nonwoven fabric deposited with nanofibers was heated for an hour by a vacuum oven at 120 degrees C. to thermally cross-link the polyglutamic acid fiber. The heating temperature during the thermal cross-linking is preferably in a range from 100 degrees C. to 120 degrees C. When the heating temperature is less than 100 degrees C., too much time is required before the cross-linking is completed. On the other hand, when the heating temperature exceeds 120 degrees C., polyglutamic acid and the base material on which polyglutamic acid is deposited may be thermally deteriorated.

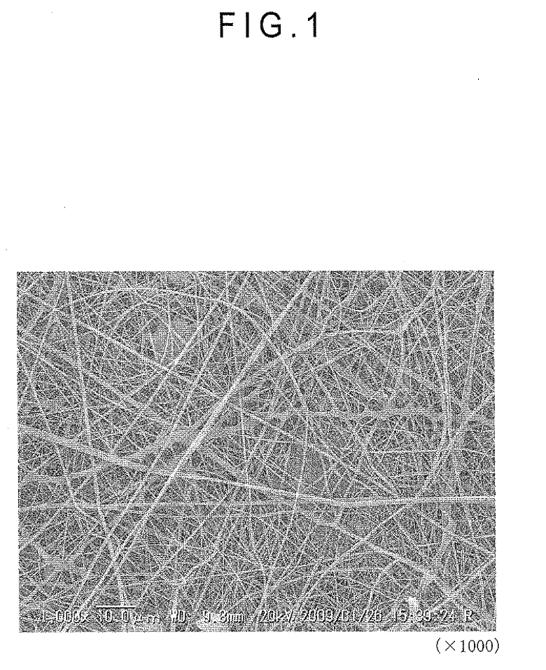

Thus obtained polyglutamic acid cross-linked fiber was tested for moisture-absorptivity and water resistance according to the following process. The results are shown in Table 1 and FIGS. 1 to 19.

### Moisture Absorption Test

The polyglutamic acid cross-linking material was left in an environment of a temperature of 23 degrees C. and humidity of 50% for twelve hours and the conditions of the fiber before and after being left in the environment were observed and the fiber diameter was measured.

The fiber diameter was measured after vapor-depositing gold on the fiber using “SC-701 GUICKCOATER” manufactured by Sanyu Electron Co., Ltd., which was subsequently observed through a 3D real surface view microscope “VE-8800” manufactured by KEYENCE CORPORATION.

### Water Resistance Test

Polyglutamic acid cross-linked fiber was immersed in water for four hours and the condition thereof was observed. After immersion, the cross-linked fiber was dried for twelve hours by a vacuum drier. The mass of the cross-linked fiber before and after immersion was used to represent a degree of insolubility (cross-linking degree) of the following formula (1). A fiber that exhibited 20% or more of degree of insolubility was determined as a polyglutamic acid cross-linked fiber that was not completely dissolved after being immersed in water.

Degree of insolubility (%)=M_{A}/M_{B}×100 (1)

In the formula (1), M_{A} represents a mass of the cross-linked fiber that is dried after being immersed in water and M_{B} represents a mass of the cross-linked fiber before being immersed in water.

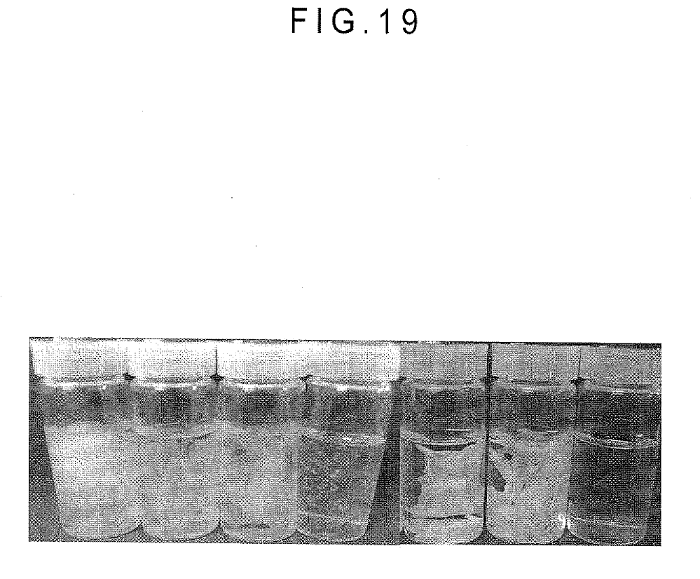

The conditions of the cross-linked fiber during the water resistance test are shown in FIG. 19. FIG. 19 shows the conditions of the cross-linked fibers according to Examples 1, 2, 3, 4, 6, 5 and Comparative Example 1 (from left to right).

The results are shown in Table 1 as follows.

### Example 1

The materials were blended at a ratio of water/ethanol/1N-HCL aqueous solution/polyglutamic acid sodium/oxazoline-group-containing polymer cross-linking agent=45 mass %/27 mass %/20 mass %/4.8 mass %/3.2 mass % to prepare a cross-linked fiber containing 60 mass % of polyglutamic acid (PGA).

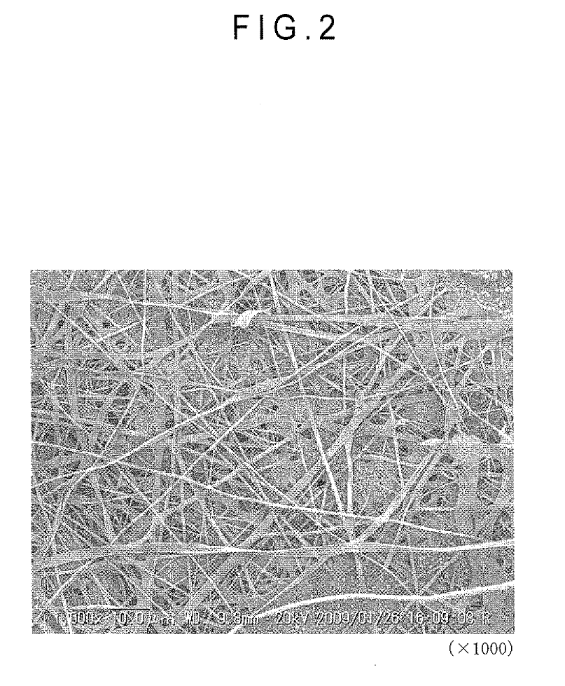

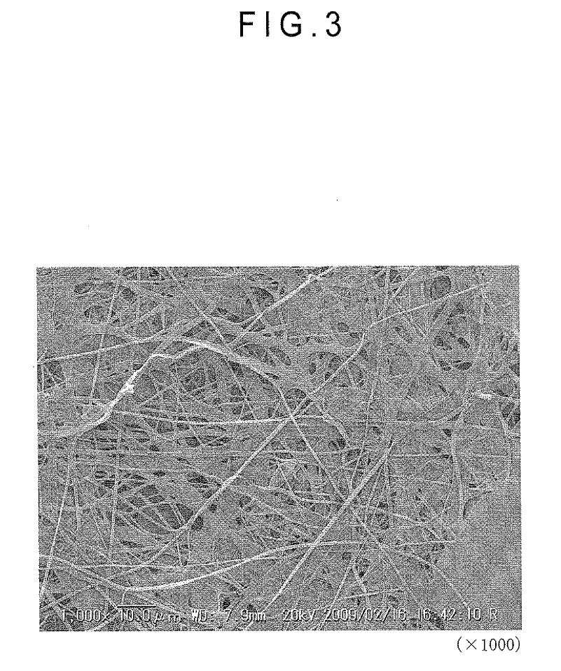

As shown in FIGS. 1 and 2, the cross-linked fiber was not dissolved after absorbing moisture. Further, as shown in FIG. 3, the cross-linked fiber retained the fibrous form even after being immersed in water. When the cross-linked fiber was dried, though the fiber became partially filmy, the fiber was not dissolved but partially retained its fibrous form.

### Example 2

The materials were blended at a ratio of water/ethanol/1N-HCL aqueous solution/polyglutamic acid sodium/oxazoline-group-containing polymer cross-linking agent=45 mass %/27 mass %/20 mass %/7.2 mass %/0.8 mass %, respectively, to prepare a cross-linked fiber containing 90 mass % of polyglutamic acid.

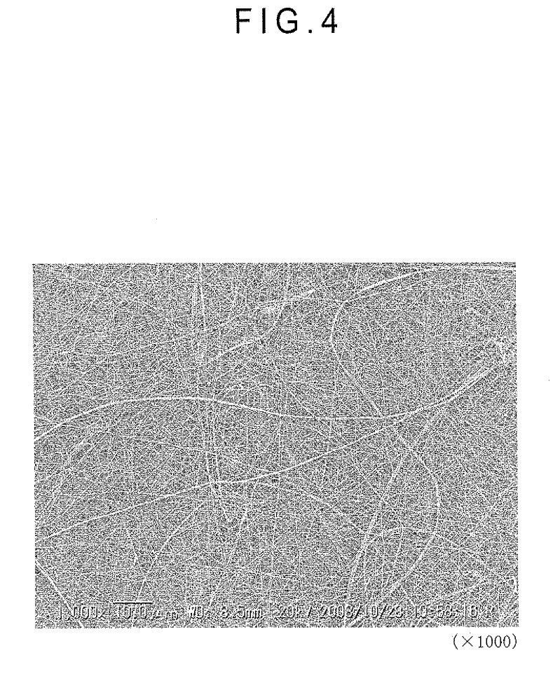

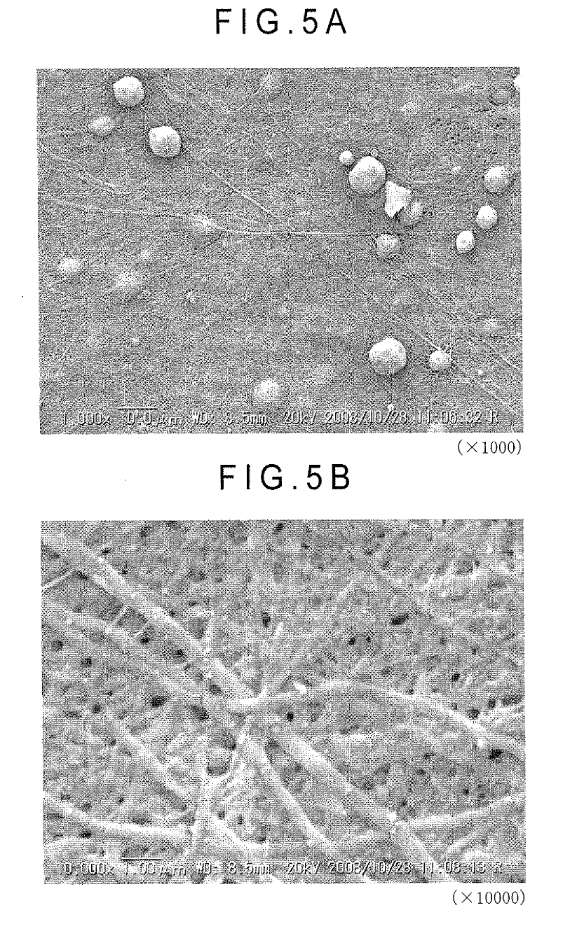

As shown in FIGS. 4, 5A and 5B, the cross-linked fiber was not dissolved after absorbing moisture. Further, when the fiber was immersed in water, though the fiber slightly became transparent and became filmy after being dried, the cross-linked fiber was not completely dissolved.

### Example 3

The materials were blended at a ratio of water/ethanol/1N-HCL aqueous solution/polyglutamic acid sodium/oxazoline-group-containing polymer cross-linking agent=45 mass %/27 mass %/20 mass %/7.7 mass %/0.3 mass %, respectively, to prepare a cross-linked fiber containing 96 mass % of polyglutamic acid.

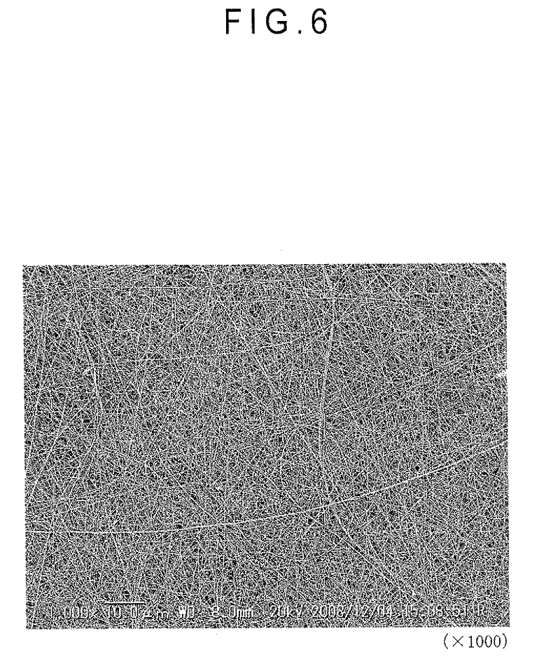

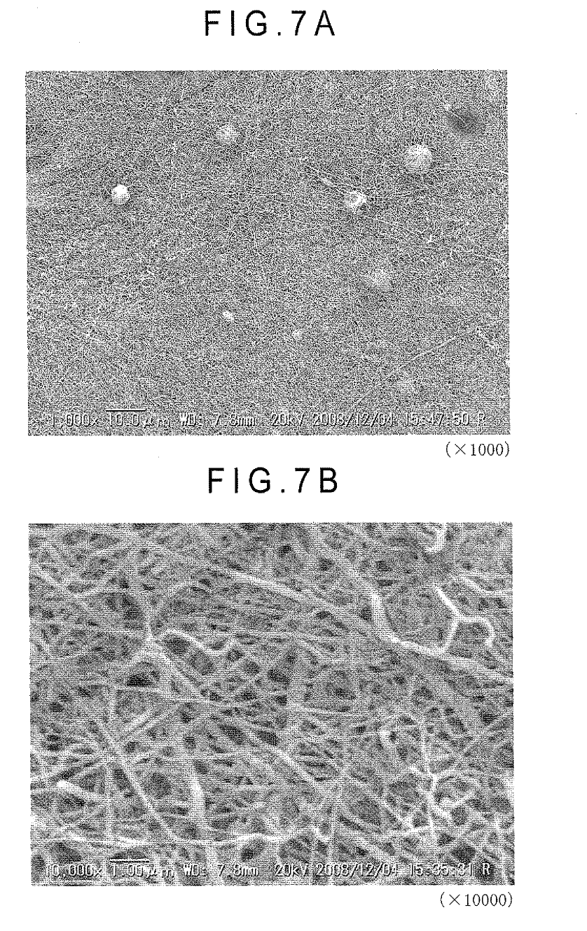

As shown in FIGS. 6, 7A and 7B, the cross-linked fiber did not dissolve after absorbing moisture. Further, when the fiber was immersed in water, though the fiber slightly became transparent and became filmy after being dried, the cross-linked fiber was not completely dissolved.

### Example 4

The materials were blended at a ratio of water/ethanol/1N-HCL aqueous solution/polyglutamic acid sodium/oxazoline-group-containing polymer cross-linking agent=45 mass %/27 mass %/20 mass %/7.94 mass %/0.06 mass %, respectively, to prepare a cross-linked fiber containing 99.3 mass % of polyglutamic acid.

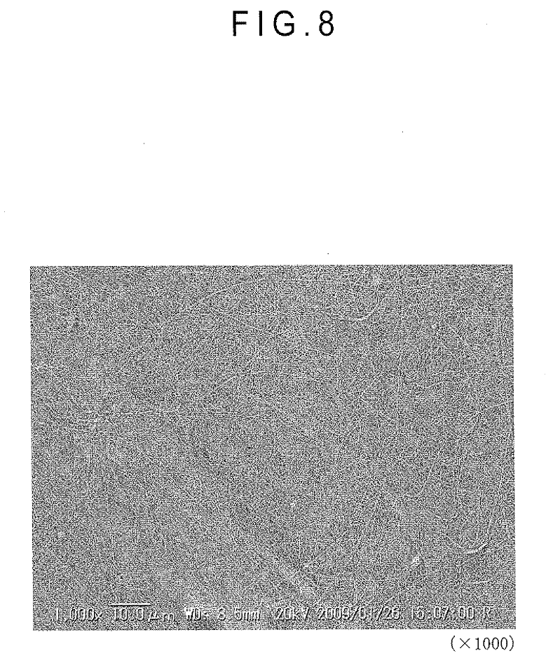

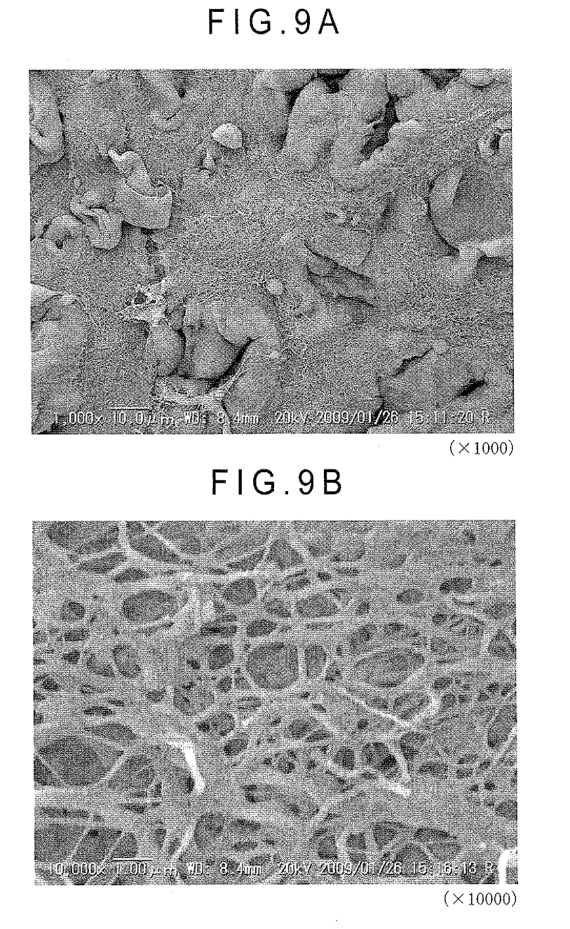

As shown in FIGS. 8, 9A and 9B, though the cross-linked fiber absorbed moisture and turned considerably filmy, the cross-linked fiber did not dissolve. Further, when the fiber was immersed in water, though the fiber considerably became transparent and became filmy after being dried, the cross-linked fiber was not completely dissolved.

### Example 5

The cross-linked fiber of Example 2 was immersed in an aqueous solution of glutaraldehyde/NaSO₄/H₂SO₄=0.06/0.96/0.4 M for twelve hours, which was washed with water and dried in vacuum to prepare a cross-linked fiber having 90 mass % of polyglutamic acid cross-linked by glutaraldehyde.

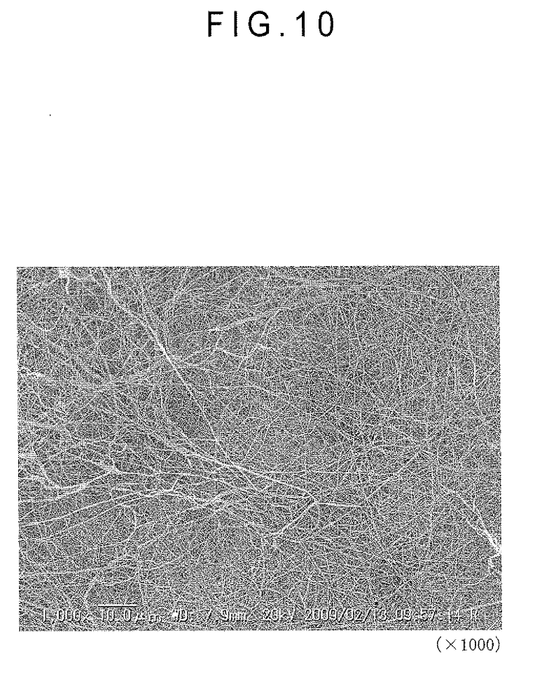

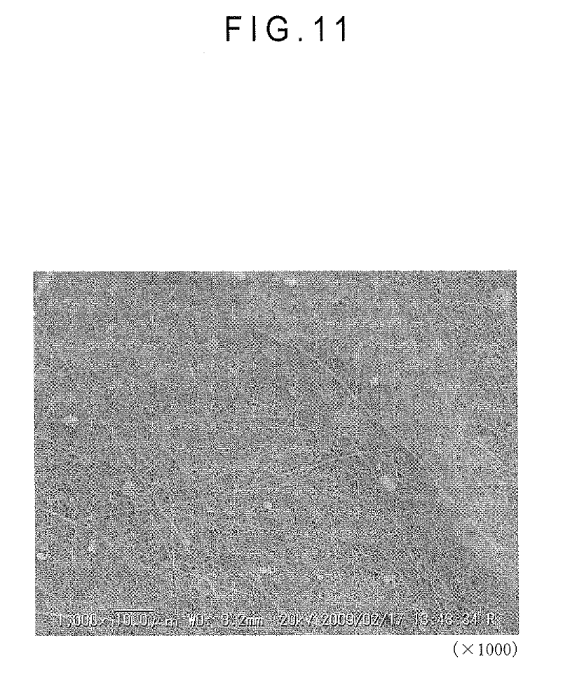

The fiber contracted when being cross-linked by glutaraldehyde, the fiber did not dissolve after absorbing moisture as shown in FIG. 10. Further, as shown in FIG. 11, the fiber retained its fibrous form after being immersed in water.

### Example 6

The cross-linked fiber of Example 2 was immersed in an aqueous solution of 0.1 M of alum for an hour, which was washed with water and dried in vacuum to prepare a cross-linked fiber having 90 mass % of polyglutamic acid subjected to an astringent process by alum water.

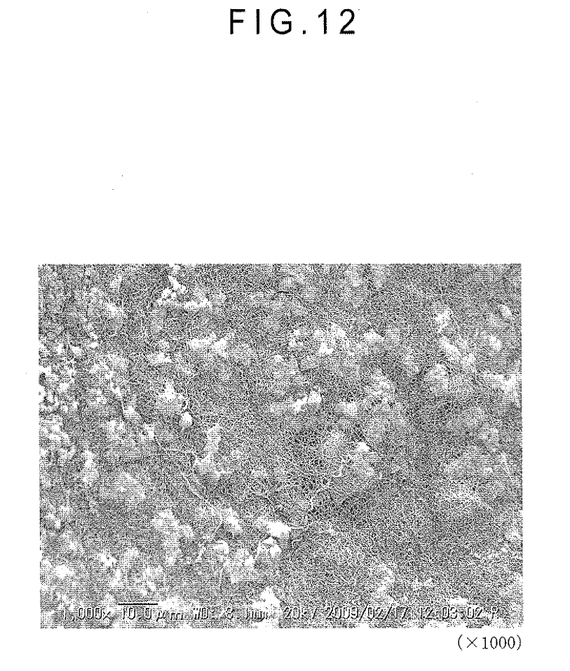

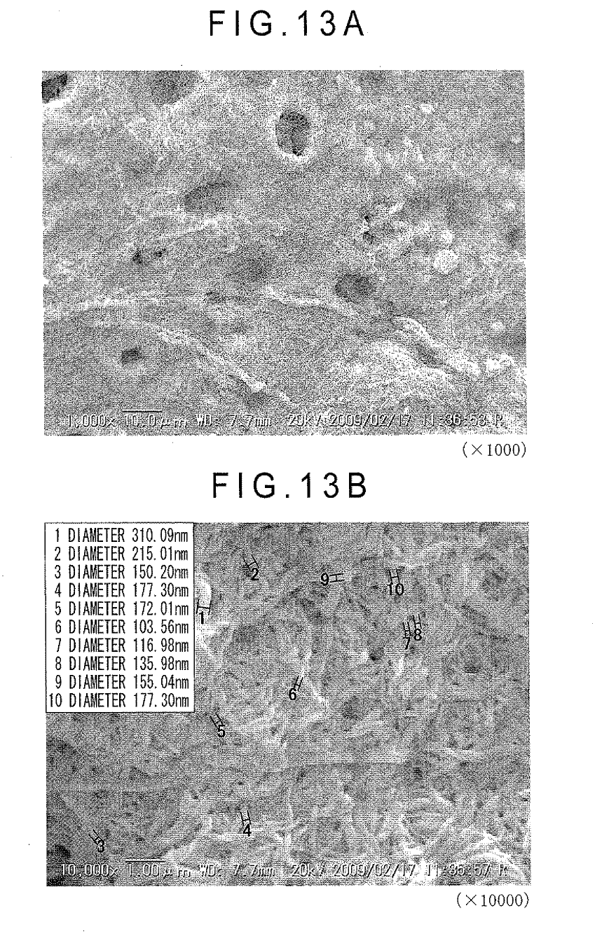

Though the fiber considerably contracted when being subjected to astringent process by alum water, the fiber did not dissolve after absorbing moisture as shown in FIG. 12. Further, as shown in FIGS. 13A and 13B, the fiber retained its fibrous form after being immersed in water.

### Example 7

The materials were blended at a ratio of water/methanol/1N-HCL aqueous solution/polyglutamic acid sodium/epoxy-group-containing polymer cross-linking agent=36 mass %/15 mass %/1 mass %/9 mass %/39 mass %, respectively, to prepare a cross-linked fiber containing 18 mass % of polyglutamic acid.

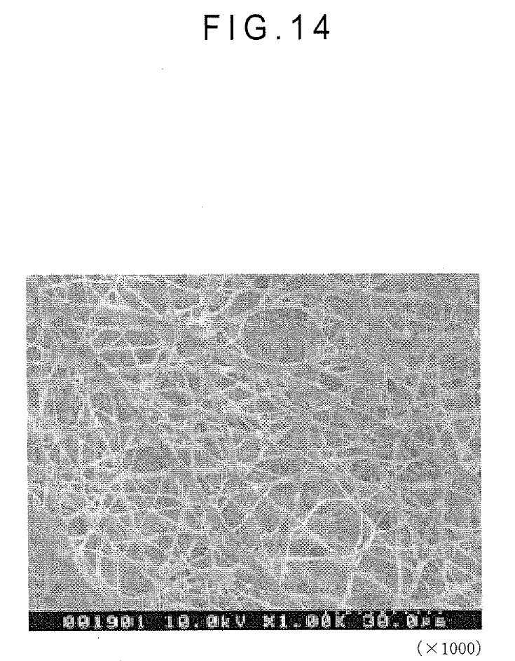

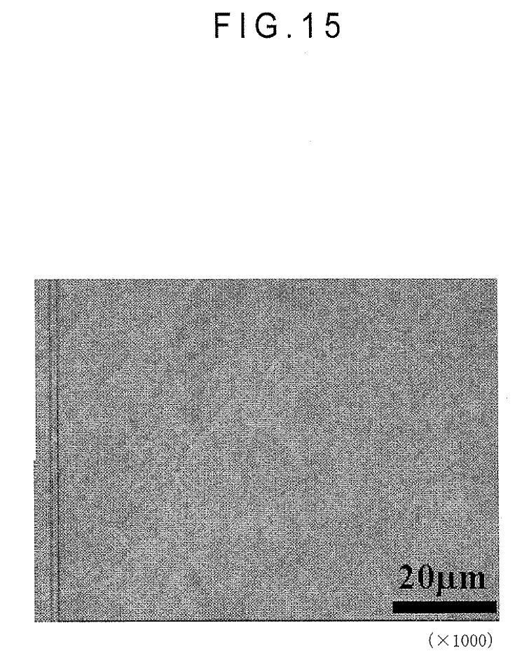

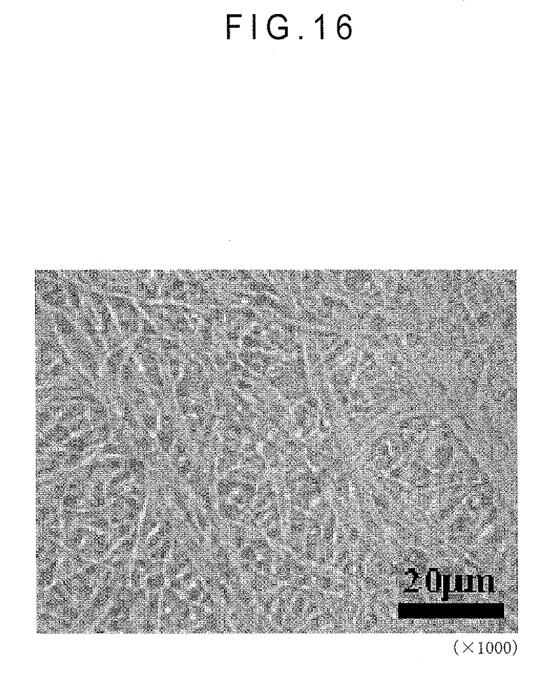

As shown in FIGS. 14 and 15, the fiber did not dissolve even after absorbing moisture. Further as shown in FIG. 16, the fiber retained its fibrous form after being immersed in water. When the cross-linked fiber was dried, though the fiber became partially filmy, the fiber was not dissolved and partially retained the fibrous form.

### Comparative Example 1

A fiber containing 100 mass % of polyglutamic acid sodium was prepared by blending water/ethanol/polyglutamic acid sodium at a ratio of 65 mass %/27 mass %/8 mass %.

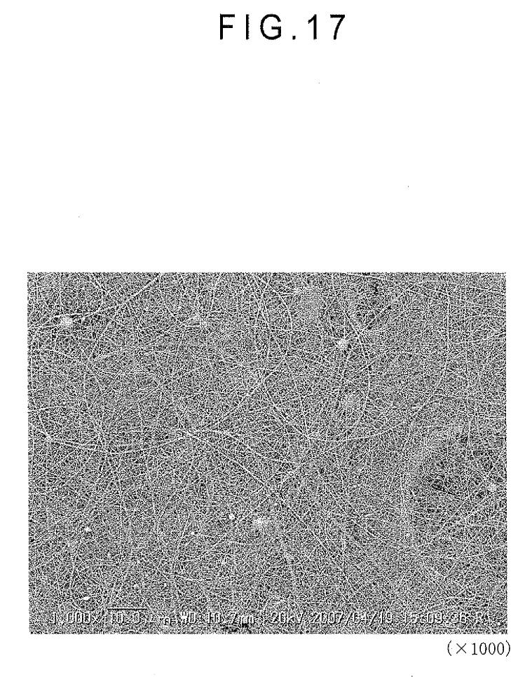

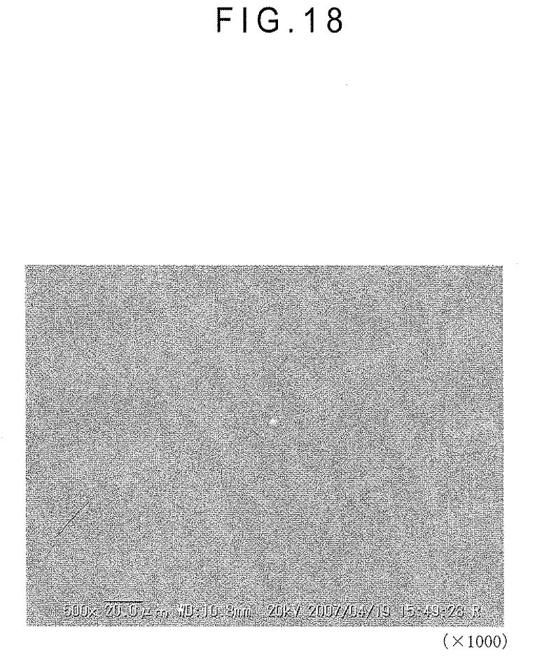

As shown in FIGS. 17 and 18, the fiber absorbed moisture and water to be completely eluted.

### Comparative Example 2

The fiber according to Comparative Example 1 was subjected to the cross-linking process according to Example 5.

The fiber completely dissolved during the cross-linking process.

### Comparative Example 3

The fiber according to Comparative Example 1 was subjected to the cross-linking process according to Example 6.

The fiber completely dissolved during the astringent process.

TABLE 1

| | PGA Blend | | | After Moisture | | After Water | | | Water |
|---|---|---|---|---|---|---|---|---|---|
| | Ratio | Before Test | | Absorption Test | | Resistance Test | | | Resistance |
| | Additional | Enlarged | Fiber | Enlarged | Fiber | Enlarged | Fiber | Condition | Cross-Linking |
| | Process | Photograph | Diameter (nm) | Photograph | Diameter (nm) | Photograph | Diameter (nm) | in Water | Degree(%) |
| Ex. 1 | 60% | FIG. 1 | 430 | FIG. 2 | 570 | FIG. 3 | 690 | Form | 81 |
| | — | | | | | | | Retained | |
| Ex. 2 | 90% | FIG. 4 | 160 | FIGS. 5A | 270 | — | — | Insoluble | 76 |
| | — | | | and 5B | | | | Matter Existed | |
| Ex. 3 | 96% | FIG. 6 | 170 | FIGS. 7A | 190 | — | — | Insoluble | 72 |
| | — | | | and 7B | | | | Matter Existed | |
| Ex. 4 | 99.3% | FIG. 8 | 150 | FIGS. 9A | 250 | — | — | Insoluble | 22 |
| | — | | | and 9B | | | | Matter Existed | |
| Ex. 5 | 90% | — | — | FIG. 10 | 230 | FIG. 11 | 200 | Form | 96 |
| | Cross- | | | | | | | Retained | |
| | Link | | | | | | | | |
| Ex. 6 | 90% | — | — | FIG. 12 | 250 | FIGS. 13A | 250 | Form | 93 |
| | Astringent | | | | | and 13B | | Retained | |
| Ex. 7 | 18% | FIG. 14 | 450 | FIG. 15 | 620 | FIG. 16 | 650 | Form | 90 |
| | — | | | | | | | Retained | |
| Co. 1 | 100% | FIG. 17 | 210 | FIG. 18 | — | — | — | — | 0 |
| | — | | | | | | | | |
| Co. 2 | 100% | — | — | Unmeasurable (completely dissolved during cross-linking) | | | | | |
| | Cross- | | | | | | | | |
| | Link | | | | | | | | |
| Co. 3 | 100% | — | — | Unmeasurable (completely dissolved during astringent process) | | | | | |
| | Astringent | | | | | | | | |

Ex...Example, Co...Comparative Example

What is claimed is:

1. A cross-linked fiber, comprising:
a hydrophilic compound including a condensing functional group; and
a polymer cross-linking agent, the hydrophilic compound and the polymer cross-linking agent being cross-linked to provide a fibrous form, wherein
a degree of insolubility represented by a formula (1) as follows is 20% or more,
Degree of insolubility (%)=M_{A}/M_{B}×100 (1)
where M_{A} represents a mass of the cross-linked fiber that is dried after being immersed in water and M_{B} represents a mass of the cross-linked fiber before being immersed in water.

2. The cross-linked fiber according to claim 1, wherein
the hydrophilic compound including the condensing functional group is polyglutamic acid.

3. The cross-linked fiber according to claim 1, wherein
the polymer cross-linking agent is a polymer having an oxazoline group.

4. The cross-linked fiber according to claim 1, wherein
the polymer cross-linking agent is a polymer having an epoxy group.

5. The cross-linked fiber according to claim 1, wherein
the cross-linked fiber is further cross-linked using a monomer cross-linking agent.

6. The cross-linked fiber according to claim 1, wherein
the cross-linked fiber is further subjected to an astringent process by an astringent agent.

7. The cross-linked fiber according to claim 1, wherein
a diameter of the fiber is in a range from 0.01 μm to 3 μm.

8. The cross-linked fiber according to claim 1, wherein
the fiber constitutes a fiber assembly.

9. The manufacturing method of cross-linked fiber according to claim 1, further comprising:
spinning threads from a solution containing the hydrophilic compound including the condensing functional group and the polymer cross-linking agent by an electrostatic spinning to form fibers and a fiber assembly; and
heating the fiber and the fiber assembly to provide the cross-linked fiber.

10. The manufacturing method of cross-linked fiber according to claim 9, further comprising:
after the heating, at least one of: cross-linking the cross-linked fiber by a monomer cross-linking agent; and an astringent process by an astringent agent.
